(19) United States
(12) Patent Application Publication
(10) Pub. No.: US 2018/0236742 A1
(43) Pub. Date: Aug. 23, 2018

(54) DUNNAGE CONVERSION SYSTEM AND METHOD FOR EXPANDING PRE-SLIT SHEET STOCK MATERIAL

(71) Applicant: Ranpak Corporation, Concord Township, OH (US)

(72) Inventors: Robert C. Cheich, Independence, OH (US); Peter J. Urban, Mentor-on-the-lake, OH (US)

(21) Appl. No.: 15/751,494

(22) PCT Filed: Jun. 24, 2016
(86) PCT No.: PCT/US2016/039169

§ 371 Date: Feb. 9, 2018

Related U.S. Application Data
(60) Provisional application No. 62/211,938, filed on Aug. 31, 2015.

(51) Int. Cl. B31D 5/00; B31D 1/00

(52) U.S. Cl. CPC B31D 5/0065; B31D 2205/0047; B31D 2205/0017; B31D 1/0031

(57) ABSTRACT

A dunnage conversion machine includes a frame, a supply support coupled to the frame for supporting a supply of expandable sheet stock material, and a pair of opposed expansion members rotatably coupled to the frame for rotation about respective axes. The expandable sheet stock material is gripped between the expansion members while it is drawn between the expansion members. Tension provided between a downstream pulling force downstream of the expansion members and the gripping force of the expansion members causes expansion of the expandable sheet stock material. Portions of the expansion members are periodically recessed to provide more uniform expansion of the expandable sheet stock material while reducing or altogether preventing jamming of expanding sheet stock material between the expansion members or tearing of the expanding sheet stock material adjacent the expansion members.

### FIELD OF THE INVENTION

This invention relates generally to a dunnage conversion system and method for converting a sheet stock material into a dunnage product, and more particularly to a dunnage conversion system and method that expands a pre-slit sheet stock material.

### BACKGROUND

In the process of shipping one or more articles from one location to another, a packer typically places some type of dunnage material in a shipping container, such as a cardboard box, along with the article or articles to be shipped. The dunnage material typically is used to wrap the articles or to partially or completely fill the empty space or void volume around the articles in the container. By filling the void volume, the dunnage prevents or minimizes movement of the articles that might lead to damage during the shipment process. The dunnage also can perform blocking, bracing, or cushioning functions. Some commonly used dunnage materials are plastic foam peanuts, plastic bubble pack, air bags, and converted paper dunnage material.

Unlike most plastic dunnage products, converted paper packing material is an ecologically-friendly packing material that is recyclable, biodegradable, and composed of a renewable resource. Expandable slit sheet paper packing material is useful as a cushioning material for wrapping articles and as a void-fill material for packages. The term expanding, as used herein, refers to a three-dimensional expansion, or a volume expansion. The material expands in length and thickness while decreasing in width, to yield about a twenty-fold increase in volume and comparable decrease in density. When the slit sheet paper is stretched in a direction transverse the direction of the slits, the paper deforms, increasing in length and thickness. This stretching and increase in thickness of the slit sheet paper packing material is referred to as expansion. Slit sheet paper packing material, and the manufacturing thereof, are described in greater detail in U.S. Pat. Nos. 5,667,871 and 5,688,578, the disclosures of which are incorporated herein by reference in their entireties.

### SUMMARY OF THE INVENTION

While many dunnage conversion machines produce an adequate dunnage product, existing dunnage conversion machines and dunnage products might not be ideal for all applications. The present invention provides a dunnage conversion machine that is compact, easy to load, and uses a pre-slit expandable sheet stock material to dispense an expanded dunnage product using less sheet stock material than previous conversion machines. The conversion machine has an improved expansion assembly that applies a consistent gripping force to the slit sheet stock material, resulting in the expanding slit sheet stock material being consistently tensioned during expansion. The consistent tensioning reduces tearing and bunching of the slit sheet stock material and produces a uniformly expanded dunnage product.

The expandable sheet stock material is a slit sheet stock material, generally a pre-slit sheet stock material, having a plurality of transversely-extending rows of slits. The rows are longitudinally spaced from one another. Each row includes a plurality of slits intermittently dispersed across the row. And the slits in each row typically are arranged in a staggered relationship relative to the slits in adjacent rows.

An exemplary dunnage conversion machine according to the invention includes a frame, a supply support coupled to the frame for supporting a supply of the expandable sheet stock material, and an expansion assembly having a pair of opposed expansion members rotatably coupled to the frame for rotation about respective axes. The expandable sheet stock material is gripped between the expansion members while it is drawn between the expansion members. Tension provided between a pulling force downstream of the expansion members and the gripping force of the expansion members causes expansion of the expandable sheet stock material. The expansion members are periodically recessed providing for uniform expansion of the expandable sheet stock material while reducing or altogether preventing jamming of expanding sheet stock material between the expansion members or tearing of the expanding sheet stock material adjacent the expansion members.

The present invention provides a dunnage conversion machine that includes a frame, a supply support coupled to the frame for supporting a supply of sheet stock material, and a pair of expansion members rotatably coupled to the frame for rotation about respective expansion axes. The expansion members are spaced apart to grip sheet stock material therebetween. The expansion members each include a plurality of recessed portions and outward portions alternatingly distributed along the respective expansion axes between opposite ends of the respective expansion members. At least some of the plurality of outward portions of a first of the expansion members being aligned with at least a portion of at least a respective one of the plurality of outward portions of a second of the expansion members to grip the sheet stock material between the opposed outward portions of the respective expansion members.

The plurality of recessed portions may extend fully circumferentially about each of the respective expansion members thereby defining recessed rings.

The plurality of recessed portions of each of the expansion members may be equally axially spaced from one another along the respective ones of the expansion axes, separated by the respective plurality of outward portions.

The plurality of recessed portions of a first of the expansion members may be axially aligned with respective ones of the plurality of recessed portions of the second of the expansion members along the expansion axes.

The plurality of recessed portions of a first of the expansion members may be axially offset from the plurality of recessed portions of the second of the expansion members along the expansion axes, such that a plurality of recessed portions of the first of the expansion members axially overlap respective ones of the plurality of outward portions of the second of the expansion members.

The plurality of recessed portions of a first of the expansion members may be alternately axially aligned with respective ones of the plurality of outward portions of the second of the expansion members along the expansion axes.

The recessed portions of the first of the expansion members may not axially overlap any of the plurality of recessed portions of the second of the expansion members along the expansion axes.

The plurality of outward portions of the expansion members may engage respective outward portions of the opposing expansion members.

Only a portion of the plurality of outward portions of the opposing expansion members may engage one another while the remainder of the plurality of outward portions of the opposing expansion members are respectively positioned such that they cannot engage one another.

Outward portions of the plurality of outward portions that are disposed adjacent opposing axial ends of the opposing expansion members may engage one another, and where outward portions of the plurality of outward portions that are disposed axially centrally along the respective expansion axes and spaced from the opposing axial ends do not engage one another.

At least one of the expansion members may be biased towards the other of the expansion members via a biasing element.

The dunnage conversion machine may be provided in combination with a supply of sheet stock material including a sheet stock material having a plurality of slits configured to expand under tension applied in a feed direction.

The supply of sheet stock material may be provided in combination with the dunnage conversion machine and may include the plurality of slits arranged in a plurality of transversely-extending, longitudinally-spaced rows.

The dunnage conversion machine may further include a second supply support for supporting a supply of separator sheet material, and in combination with a supply of separator sheet material supported on the second supply support.

The plurality of outward portions of a first of the expansion members may be interwoven with the plurality of recessed portions of the second of the expansion members such that the plurality of outward portions of the first of the expansion members extend radially outwardly into and are received by the plurality of recessed portions of the second of the expansion members.

The expansion axes may be generally parallel one another.

The present invention also provides a dunnage conversion machine that includes a frame, a supply support coupled to the frame for supporting a supply of sheet stock material, and a pair of opposed expansion members downstream of the supply support extending between opposed axial ends. The expansion members are rotatably coupled to the frame for rotation about respective opposed axes. Sheet stock material is drawn from the supply of sheet stock material between the expansion members. A biasing element is coupled to at least one of the expansion members to bias the at least one of the expansion members towards the other of the expansion members to maintain a consistent gripping force on the sheet stock material between the expansion members. The pair of opposed expansion members and biasing element are configured to provide equivalent force at the opposed axial ends of the expansion members on sheet stock material drawn between the opposed expansion members, but non-uniform force across the width of the sheet stock material extending between the axial ends of the expansion members.

The dunnage conversion machine may further include an adjustment member coupled to the biasing element and to the frame, such that the biasing force of the biasing element may be adjusted.

The dunnage conversion machine may further include another biasing element coupled to the at least one of the expansion members, such the biasing element and the another biasing element are oppositely disposed at the opposed axial ends of the at least one of the expansion members.

The present invention further provides a method of dispensing an expanded slit sheet stock material. The method uses a dunnage conversion system including a frame, a supply of expandable sheet stock material supported on a supply support coupled to the frame, and a pair of opposed expansion members downstream of the supply support for gripping the sheet stock material passing between the expansion members. The method includes the steps of (a) pulling the sheet stock material at a location adjacent an output of the system in a direction outwardly from the system, (b) maintaining consistent gripping force on the sheet stock material drawn between the expansion members, and (c) expanding the expandable sheet stock material via tension between the pulling force at the output and the gripping force applied to the sheet stock material by the expansion members.

The present invention also provides a dunnage conversion machine that includes a frame and a support means coupled to the frame for supporting a supply of expandable sheet stock material. The dunnage conversion machine also includes a gripping means downstream of the supply support for applying a consistent gripping force to sheet stock material as it is drawn from the supply, the gripping means facilitates uniform expansion of the sheet stock material as it is tensioned between the gripping means and a pulling force downstream of the gripping means.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

FIG. 1 is a front orthogonal view of an exemplary dunnage conversion system provided in accordance with the present invention including both a dunnage conversion machine and supplies of sheet stock material.

FIG. 2 is partial front view of the exemplary dunnage conversion system of FIG. 1, showing the expanded dunnage product being output from the system.

FIG. 3 is a side orthogonal view of the exemplary dunnage conversion system of FIG. 1.

FIG. 4 is a rear orthogonal view of the exemplary dunnage conversion system shown in FIG. 1.

FIG. 5 is partially schematic cross-sectional view of the biasing assembly of the exemplary dunnage conversion system of FIG. 1, showing the path of stock material through the system.

FIG. 6 is a front orthogonal view of the exemplary dunnage conversion machine shown in FIG. 1 with the supplies shown separated from the machine.

FIG. 7 is a front view of the dunnage conversion machine shown in FIG. 6.

FIG. 8 is a rear orthogonal view of the dunnage conversion machine shown in FIG. 6.

FIG. 9 is a rear view of the dunnage conversion machine shown in FIG. 6.

FIG. 10 is a top view of the dunnage conversion machine shown in FIG. 6.

FIG. 11 is a side view of the dunnage conversion machine shown in FIG. 6.

FIG. 12 is an enlarged partial side view of an expansion assembly portion of the exemplary dunnage conversion machine shown in FIG. 6.

FIG. 13 is partial diagram view of an exemplary expansion assembly of the exemplary dunnage conversion machine of FIG. 6.

FIG. 14 is a partial diagram view of another exemplary expansion assembly of the exemplary dunnage conversion machine of FIG. 6.

FIG. 15 is a partial diagram view of yet another exemplary expansion assembly of the exemplary dunnage conversion machine of FIG. 6.

FIG. 16 is a partial diagram view of still another exemplary expansion assembly for use with the dunnage conversion machine of FIG. 6.

FIG. 17 is a partial diagram view of a further exemplary expansion assembly of the exemplary dunnage conversion machine of FIG. 6.

FIG. 18 is a partial diagram view of another exemplary expansion assembly of the exemplary dunnage conversion machine of FIG. 6.

FIG. 19 is a partial view of a biasing assembly portion of the expansion assembly of the dunnage conversion machine of FIG. 6.

### DETAILED DESCRIPTION

The present invention provides an improved apparatus for manually producing an expanded slit sheet packaging material from a supply of unexpanded slit sheet material that facilitates producing a dunnage product with more uniform expansion, improving yield and performance.

The dunnage conversion machine includes a means for supporting a supply of the unexpanded slit sheet material. The dunnage conversion machine also includes a gripping means downstream of the supply support for applying a consistent gripping force to the unexpanded slit sheet material as it is drawn from the supply, the gripping means facilitates uniform expansion of the sheet material as it is tensioned between the gripping means and a pulling force downstream of the gripping means.

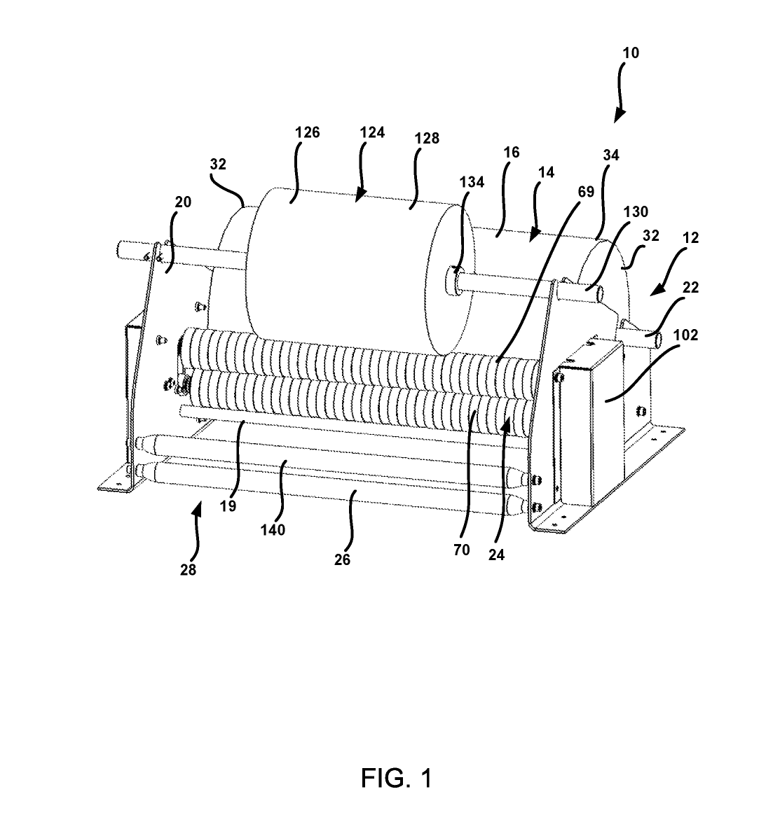

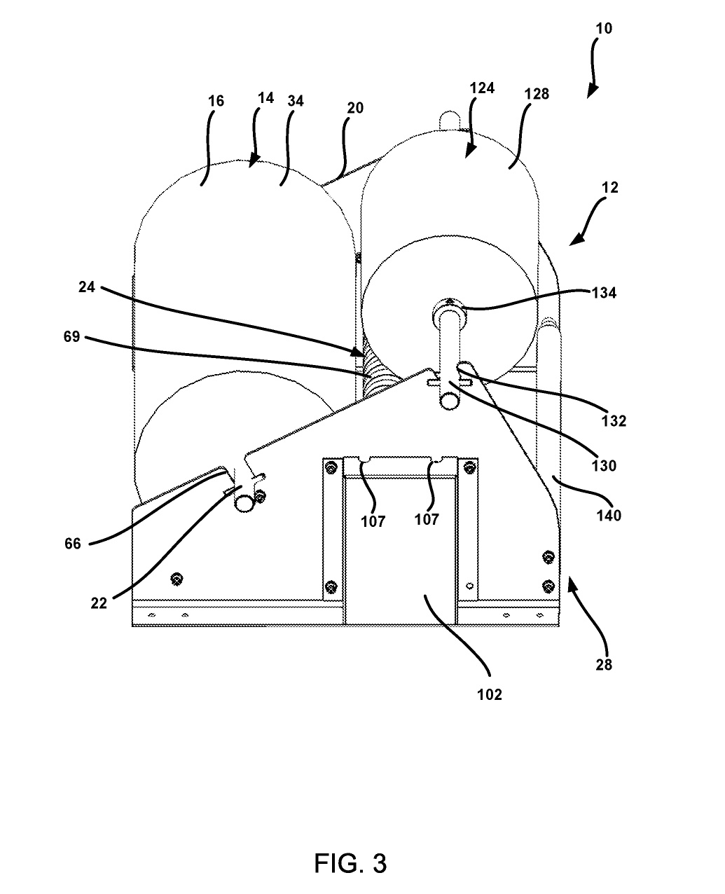

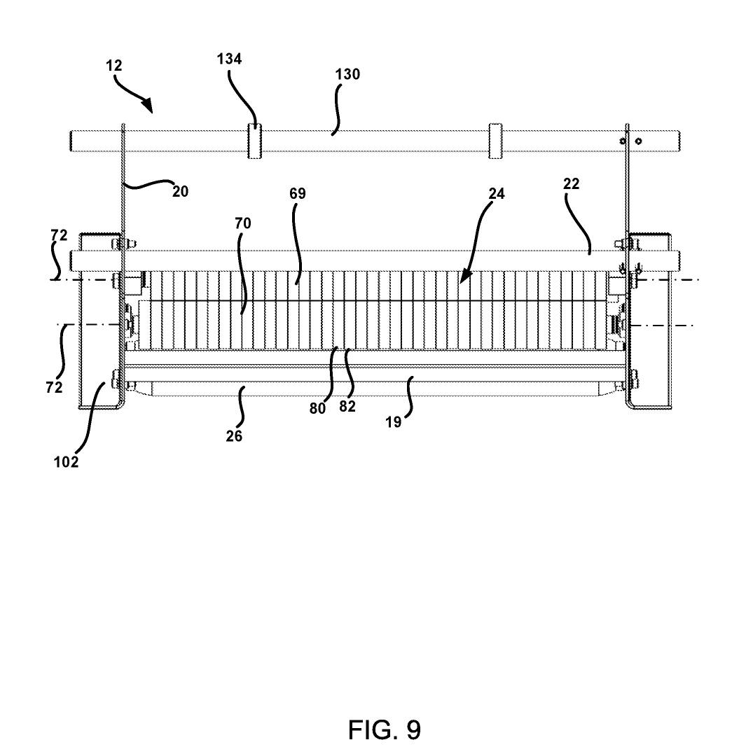

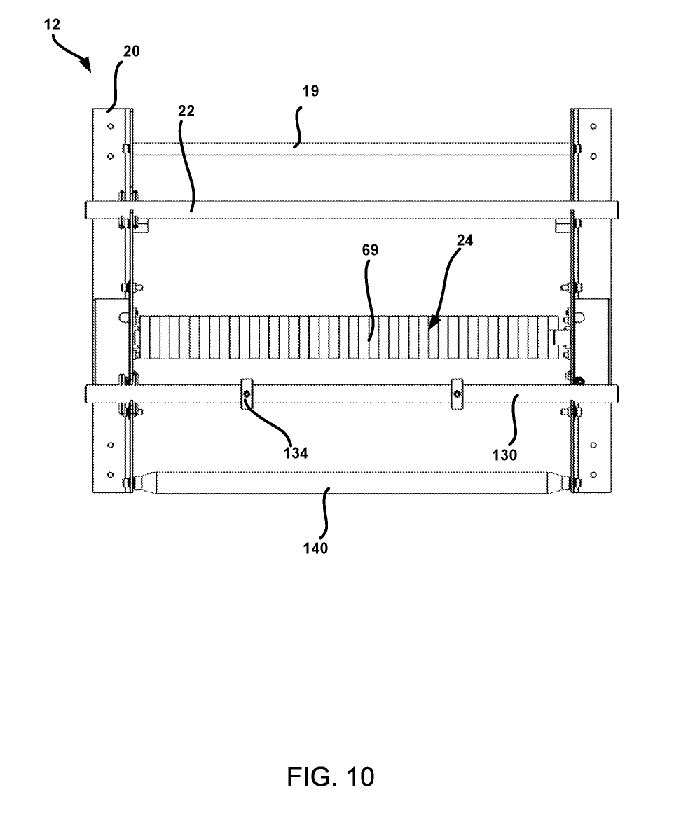

Referring now to the drawings in detail, FIGS. 1 to 13 illustrate an exemplary dunnage conversion system 10 including both a dunnage conversion machine or apparatus 12 and a supply 14 of sheet stock material. The conversion machine 12, also herein referred to as an expanding machine, dunnage expanding machine, or converter, enables an operator to produce a more uniformly expanded dunnage product from the supply 14.

The supply 14 of sheet stock material 16 includes sheet stock material that has been slit and typically includes one or more plies. As shown, the sheet material 16 generally is supplied in one or more rolls 34. The sheet material 16 in the roll may be such as wound about a hollow core that may be received on a respective supply support 22, such as an axle rotates with the hollow core or about which the hollow core rotates as the sheet material is unwound off the roll. In other embodiments the sheet material 16 may be additionally or alternatively provided in another suitable arrangement, such as in a fan-folded stack, where the material is alternatingly folded into a stack of generally rectangular pages.

An exemplary sheet material 16 is paper, such as kraft paper, and more particularly, is a single-ply kraft paper. Suitable kraft paper may have various basis weights, such as twenty-pound or forty-pound, for example. In some embodiments, the sheet material 16 may be laminated or may include any other suitable material such as another paper, plastic sheets, metal foil, or any combination thereof.

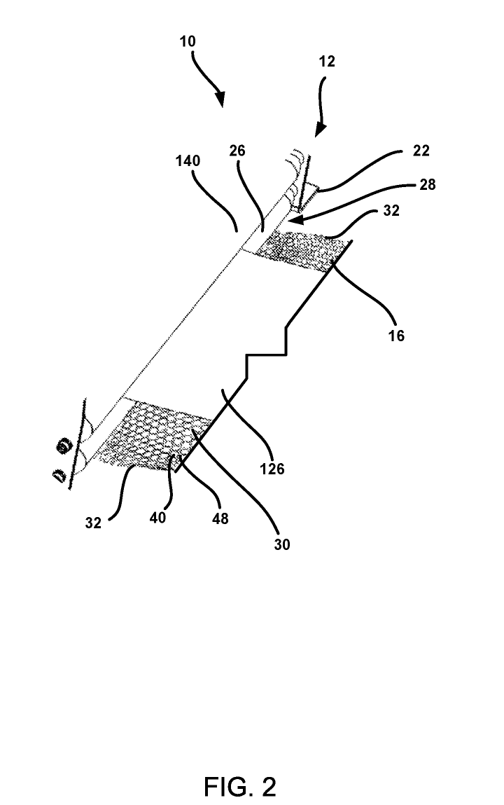

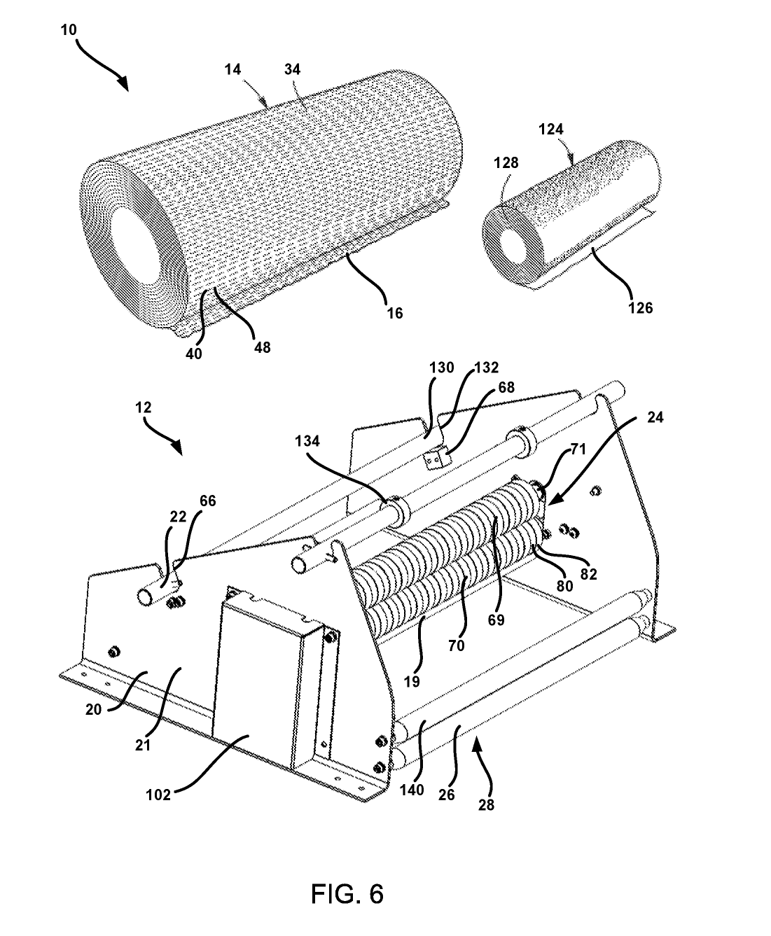

An exemplary sheet material 16 has a plurality of longitudinally-spaced, transversely-extending rows of slits cut into the sheet. More particularly, the exemplary sheet material 16 with its plurality of slits 40 (FIGS. 2 and 6) is configured to expand along a feed direction as it travels through the converter 12. In other words, the sheet material adjacent an upstream side of the slit separates from the sheet material adjacent a downstream side of the slit. The slits may be formed by cutting the sheet material, or otherwise weakening the sheet material intermittently across the sheet material so that the sheet material separates across the slit under longitudinal tension provided in the direction of advancement.

In the illustrated embodiment, the slits 40 are cut through the sheet material 16 and extend in a lateral direction across the width of the sheet material 16 between the lateral edges 32. The lateral direction is transverse a longitudinal feed direction of the material 16 through the converter 12. The converter 12 provided by the invention may be used with a supply 14 of sheet stock material with a different arrangement of slits.

Typically, the slits 40 are provided in rows, such as longitudinally-spaced lateral rows, that are generally parallel to one another and are generally periodically, and typically equally, spaced from one another. Though in other embodiments the rows may be otherwise suitably arranged relative to one another. The slits 40 are intermittently dispersed across the rows, with the slits 40 of each row generally being staggered in relation to slits 40 of directly adjacent rows. Across each row of slits 40, there may be a greater length of combined slits 40 than a length of un-slit portions 48 (FIGS. 2 and 6) disposed between slit endpoints, providing for an optimum amount of expansion of the slit sheet material 16.

This exemplary slit sheet material 16 is configured for expanding in one or more dimensions, also herein referred to as volume expansion or volumetric expansion. When the sheet material 16 is stretched in a direction transverse the direction of the slits, typically in a longitudinal feed direction, perpendicular to a width dimension of the roll of sheet material 16, the paper's longitudinal length and its thickness increase, while the paper's lateral width dimension decreases. The increased thickness as the sheet material 16 is stretched longitudinally is caused at least in part via portions of the sheet material 16 between the rows of slits rotating relative to the plane of the unexpanded sheet material 16. The thickness dimension extends in a normal direction relative to a face of the sheet material. The normal direction is defined as generally orthogonal to the paper's longitudinal length and also generally orthogonal to a lateral extent between lateral edges 32 (FIG. 2) of the sheet material.

The thickness of the slit sheet material 16 can increase by an order of magnitude, or more, relative to its original thickness, when stretched in this manner. The expanded slit sheet material 16 has an increased length and thickness and reduced width as compared to the unexpanded slit sheet material 16. This longitudinal stretching and increase in thickness, in addition to the random crumpling of the paper to be further explained, results in the volumetrically expanded dunnage product 30 (FIG. 2). The increased volume allows the expanded dunnage product 30 to serve as a perforate protective void-fill or cushioning wrap for packaging articles in containers.

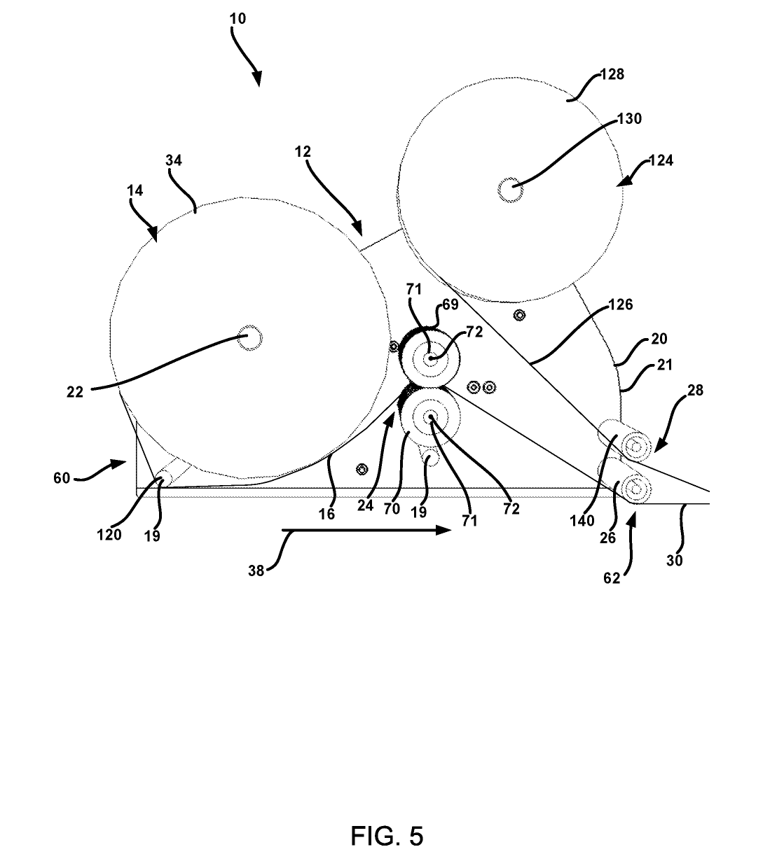

Referring now in particular to FIG. 5, the converter 12 generally includes a housing, such as a frame 20. Coupled to the frame 20 are one or more means for supporting sheet material, such as one or more supply supports 22. A means for gripping the sheet material as it is drawn from the one or more supply supports 22 may include an expansion assembly 24. The expansion assembly 24 is spaced downstream of the one or more supply supports 22. As used herein, coupling may refer to direct or indirect coupling. One or more guide members, such as guide rollers 26, are further disposed downstream of the expansion assembly 24 for guiding the sheet material at an output area 28 of the converter 12. The converter 12, cooperates with the supply 14 of slit sheet stock material 16 to produce the resultant expanded slit sheet packaging material 30, i.e., the expanded dunnage product 30.

The unexpanded slit sheet material 16 is fed from the expandable material supply 14 in a downstream direction 38 through the expansion assembly 24 toward the converter output area 28. The unexpanded slit sheet material 16 cooperates with the expansion assembly 24 to cause the unexpanded (and expandable) material 16 to be stretched and expanded. When stretched, the slits 40 (FIG. 2) expand and at least a portion of the un-slit portions 48 turn out of the general plane of the material. As described, the material expands longitudinally, in thickness and in length, and thus the unexpanded slit sheet material 16 converts to the resultant expanded form of expanded slit sheet packaging material 30. The sheet material 16 may be drawn manually through the converter 12, such as via an operator grasping and pulling manually on the expanded material 30 at the output area 28. In other embodiments, at least a portion of the sheet material 16 may be automatically drawn through the converter 12. For example, powered drive rollers may be provided, such as adjacent the output area 28 downstream of the expansion assembly 24.

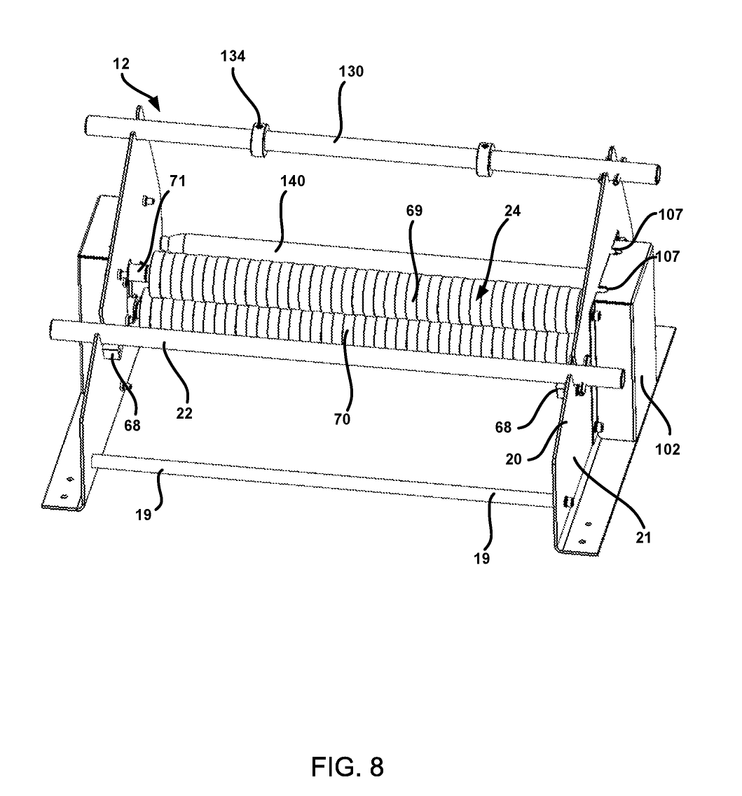

The converter 12 is shown in FIGS. 6-11 with a supply 14 (FIG. 1) of sheet stock material 16 separated from the converter 12 to facilitate description of the elements of the converter 12. The frame 20 can be a single, unitary structure, or can be formed of separate components, but it typically encloses the path of the sheet material between the supply support 22 and the output area 28. As depicted the frame 20 includes opposing vertically extending frame sides 21 laterally separated from one another. As shown best in FIG. 8, the frame sides 21 may be coupled to one another via a base portion (not shown) or via one or more cross-beams 19.

The frame 20, and thus the converter 12, extends between an upstream end 60 and a downstream end 62, the downstream end 62 being adjacent the output area 28. Accordingly, the downstream direction 38 (FIG. 5) generally is in a direction from the upstream end 60 towards the downstream end 62, in reference to a path of the slit sheet material 16 (FIG. 1) as it moves through the converter 12 in the downstream direction 38 from the supply support 22 to through the expansion assembly 24 and towards the output area 28.

The supply support 22 is coupled, such as rotatably coupled, to the frame 20 to support the supply 14 of unexpanded slit sheet stock material 16. In other embodiments the supply support 22 may be fixedly coupled to the frame 20 and the supply 14 may rotate about the supply support 22. As shown, the supply support may be an axle extending between opposite frame sides 21 extending between the upstream and downstream ends 60 and 62 of the converter 12. The axle rotates about a supply support axis and as sheet material is drawn from the roll 34, the roll 34 of sheet stock material rotates about the supply support axis or an axis near the supply support axis.

The frame sides 21 may include indents 66, such as notches, for receiving the supply support 22 in rod form. The depicted rod-form support 22 is coupled, such as seated, in the indents 66. In other embodiments, the supply support 22 may be otherwise suitably coupled, such as via bolts or capped ends, etc. The frame sides 21, and particularly the area of the indents 66, may be coated to reduce friction between the frame 20 and the supply support 22. Additionally or alternatively the supply support 22 may include such coating.

In other embodiments where the supply is a fan-folded stack of paper, the supply support may include a shelf for supporting the stack of paper as it is drawn from the shelf. The shelf may cooperate with the frame sides 21 to support the stack of paper and guide the paper from the stack towards the expansion assembly 24.

One or more additional guide portions, such as guide blocks 68 may be provided, such as attached or integral with the frame 20, for aligning and guiding the sheet material between the frame sides 21. As depicted, exemplary guide blocks 68 are provided adjacent the supply 14 of sheet material 16 (FIG. 5). As shown, a pair of opposing guide blocks 68 are attached such as via bolts to respective frame sides 21 and extend axially inwardly towards one another. The guide blocks 68 may be attached via any other suitable method, such as via welding, adhesives, notch and key, etc. in other embodiments.

The guide blocks 68 may be of any suitable shape. The depicted pair of guide blocks 68 are positioned to engage the roll 34 of sheet stock material 16. The guide blocks 68 are located generally upstream of the expansion assembly 24, to assist in maintaining lateral centering alignment of the roll 34 of sheet material between the frame sides 21. This centering aids in preventing jamming of the sheet material between the supply 14 and the expansion assembly 24. The guide blocks 68 may additionally or alternatively may aid to prevent or minimize binding between the supply support 22 and the frame sides 21.

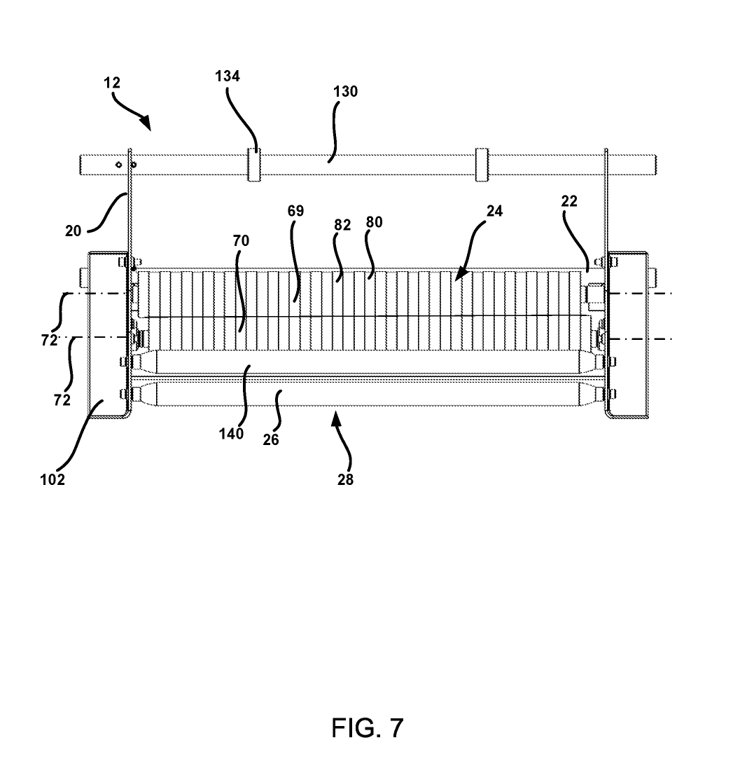

The means for gripping the sheet material 16 drawn from the roll 34 may include the expansion assembly 24, or more particularly may include expansion members 69 and 70 of the expansion assembly 24. The expansion assembly 24 is located downstream of the supply support 22. The expansion assembly 24 includes a pair of adjacent expansion members 69 and 70 coupled, such as rotatably coupled, to the frame 20 for rotation about respective expansion axes 72 (FIG. 7). The sheet stock material 16 is gripped between the expansion members 69 and 70 while being drawn through the expansion assembly 24.

The expansion members 69 and 70 cooperate with one another to apply gripping force to sheet material 16 between the expansion members 69 and 70 to slow the passage of the sheet material 16 therebetween. When an operator applies a force on the sheet stock material 16 by pulling the sheet material 16 in a longitudinal, downstream direction, this gripping allows for expanding tension to be applied to the sheet material 16 between the expansion assembly 24 and a downstream pulling force applied at the output area 28 of the converter 12 in the downstream feed direction 38.

The expansion members 69 and 70 are closely spaced to engage the relatively thin unexpanded sheet material 16. Depending on the resiliency of the expansion members 69 and 70, a portion of each expansion member 69 and 70 may engage the other of the expansion members 69 and 70, even absent the slit sheet material 16 between these portions of the expansion members 69 and 70. Portions of the expansion members 69 and 70 may be slightly separated from one another to allow efficient passage of a thickness of sheet stock material 16, though these portions may be close enough to one another to apply adequate gripping force to the sheet stock material 16 passing therebetween.

One or more of the expansion members 69 and 70 may be supported on an expansion axle 71 coupled to the frame 20, such as rotatably coupled or fixedly coupled. Thus the axles 71 extend along the respective expansion axes 72. In other embodiments, one or more of the expansion members 69 and 70 and the associated axle 71 may be integral with one another.

The expansion axes 72 are aligned generally parallel to one another, though the axes 72 may not be exactly parallel. In the depicted embodiment, the expansion axes 72 are aligned with one axis 72 aligned vertically above the other axis 72 such that the axes 72 are in a plane that is orthogonal to the base of the frame 20. In other embodiments, one of the axes 72 may be slightly forward (downstream) or behind (upstream) the other of the axes 72.

The expansion members 69 and 70 are coupled to the frame 20 between the frame sides 21 via any suitable means, such as via bolting. Alternatively, only one of the expansion members may be rotatable, and one or both of the expansion members 69 and 70 may be driven, such as via a motor. The expansion members 69 and 70 may include any suitable bushings or bearings for aiding in rotation of the expansion members 69 and 70 relative to the frame 20, or for spacing lateral ends of the expansion members 70 from the frame sides 21. In other embodiments, additional or alternative expansion members 69 and 70 may not extend fully between the frame sides 21. Further, although a single pair of expansion members 69 and 70 is depicted, additional expansion members 69 or 70 or pairs of expansion members 69 and 70 may be included.

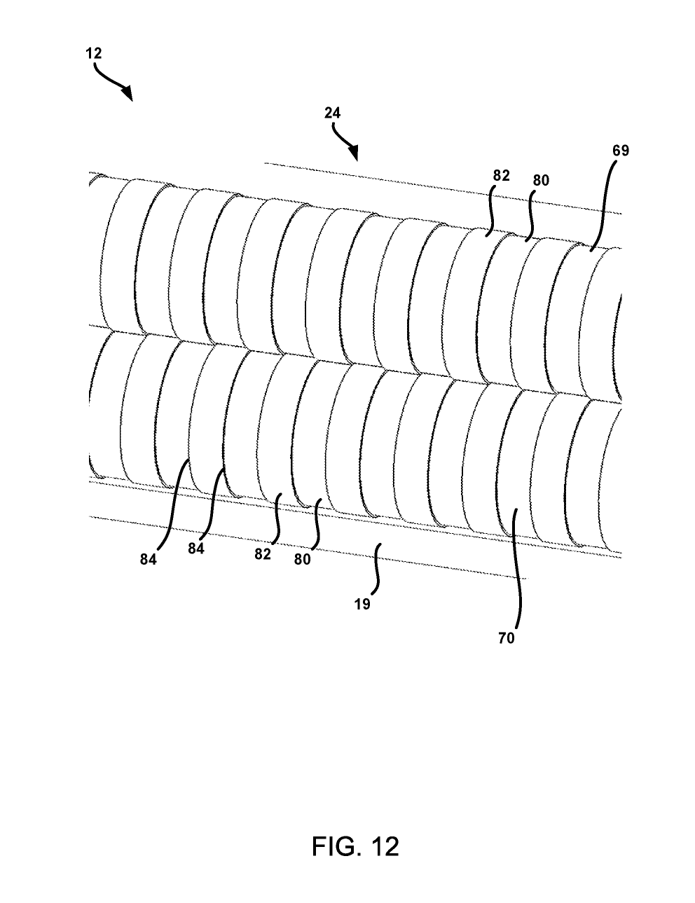

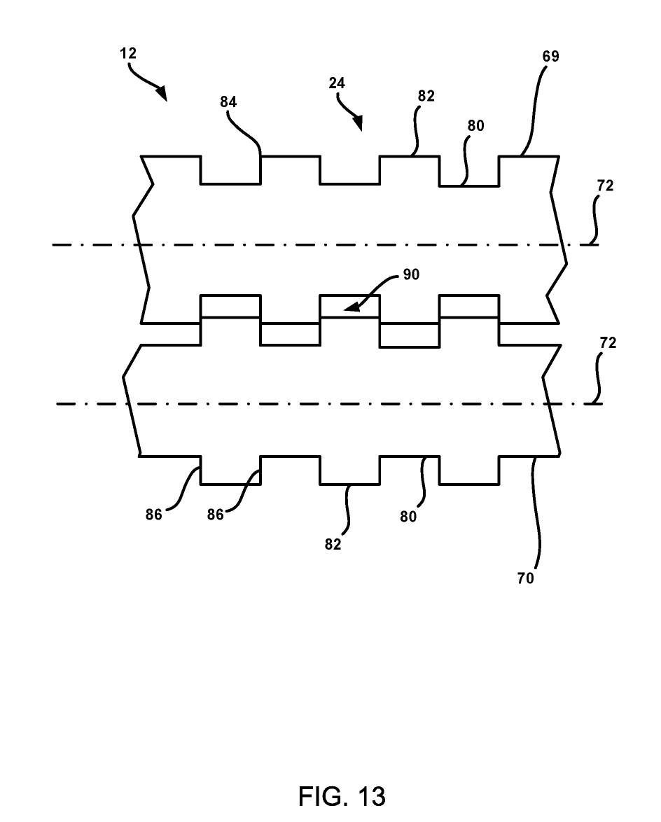

Turning again to the depicted expansion members 69 and 70, and particularly to FIGS. 12 and 13, the expansion members 69 and 70 are depicted as periodically relieved rollers (alternatively referred to as periodically recessed), such as periodically relieved cylindrical rollers, though the expansion members 69 and 70 may of any other suitable shape in other embodiments. The expansion members 69 and 70 each include a plurality of recessed portions 80 and a plurality of outward portions 82 alternatingly distributed along the respective expansion axes 72 (FIG. 7) between laterally opposite ends of the respective expansion members 69 and 70. The plurality of outward portions 82 extend radially outwardly further than the plurality of recessed portions 80.

The depicted expansion members 69 and 70 include recessed and outward portions 80 and 82 that extend fully circumferentially about each of the respective expansion members 69 and 70 thereby defining a series of recessed and outward rings. As depicted, the rings are annular and have surfaces that are concentrically disposed about the respective expansion axes 72. In other embodiments, the recessed and outward portions 80 and 82 may define any other suitable shapes, such as being elliptical rings or having jagged or curved edges, rather than straight edges as depicted. In some embodiments, the outward portions 82 may have beveled or rounded edges 84. Additionally or alternatively, the recessed or outward portions 80 and 82 may only extend partially circumferentially about the respective expansion members 69 and 70.

Each recessed portion 80 extends axially along the respective expansion axis 72 between opposed circumferentially extending lateral sides 86 at the edges of the outward portions 82. As depicted, each of the recessed portions 80 have equal axial widths extending between the respective lateral sides 86. Likewise, each of the outward portions 82 have equal axial widths extending between their respective lateral sides 86. The axial widths of the recessed portions 80 may have different dimension than the axial widths of the outward portions 82, with the outward portions 82 having greater axial widths in the depicted embodiment.

Accordingly, the plurality of recessed portions 80 of each of the expansion members 69 and 70 are equally axially spaced from one another along the respective ones of the expansion axes 72 by respective outward portions 82. And likewise, the plurality of outward portions 82 of each of the expansion members 69 and 70 are equally axially separated from one another along the respective one of the expansion axes 72 by respective ones of the plurality of recessed portions 80. In other embodiments, the recessed portions 80 may have different axial widths, the outward portions 82 may have different axial widths, or the axial widths of the recessed portions 80 and of the outward portions 82 may be equal to one another, or a combination thereof. For example, the axial widths of the recessed portions 80 and of the outward portions 82 may vary along the lateral length of the respective axes 72.

In the illustrated embodiment, the plurality of recessed portions 80 of each of the expansion members 69 and 70 are axially offset from the plurality of recessed portions 80 of the other of the expansion members 69 and 70 along the respective expansion axes 72. The plurality of recessed portions 80 of each the expansion members 69 and 70 are alternately axially aligned with respective ones of the plurality of outward portions 82 of the other of the expansion members 69 and 70 along the respective expansion axes 72. Thus, each of the recessed portions 80 of each of the expansion members 69 and 70 is axially aligned with a corresponding outward portion 82 of the other of the expansion members 69 and 70.

In this way, as the sheet stock material 16 is drawn between the expansion members 69 and 70, the sheet stock material 16 can be gripped between an outward portion 82 of one of the expansion members 69 and 70 and a corresponding recessed portion 80 of the other of the expansion members 69 and 70. Outer surfaces of the expansion member 69 and 70, and particularly outer surfaces of the outward portions 82, are made of a material that provides sufficient friction relative to the sheet material 16 to draw the sheet material 16 between the expansion members 69 and 70.

Further, as shown in FIGS. 12 and 13, the plurality of outward portions 82 of each of the expansion members 69 and 70 are interwoven with the plurality of outward portions 82 of the other of the expansion members 69 and 70. In this way, the plurality of outward portions 82 of a first (upper) of the expansion members 69 extend into and are received between respective ones of the plurality of outward portions 82 of the second (lower) of the expansion members 70, and vice versa. For example, radial outer extent of the outward portions 82 of the first expansion member 69 extend beyond the radial outer extent of the outward portions 82 of the second expansion member 70. Consequently, the sheet material 16 drawn between the expansion members 69 and 70 is likewise gripped between engaged or nearly engaged lateral sides 86 of the interwoven outward portions 82 of each of the expansion members 69 and 70.

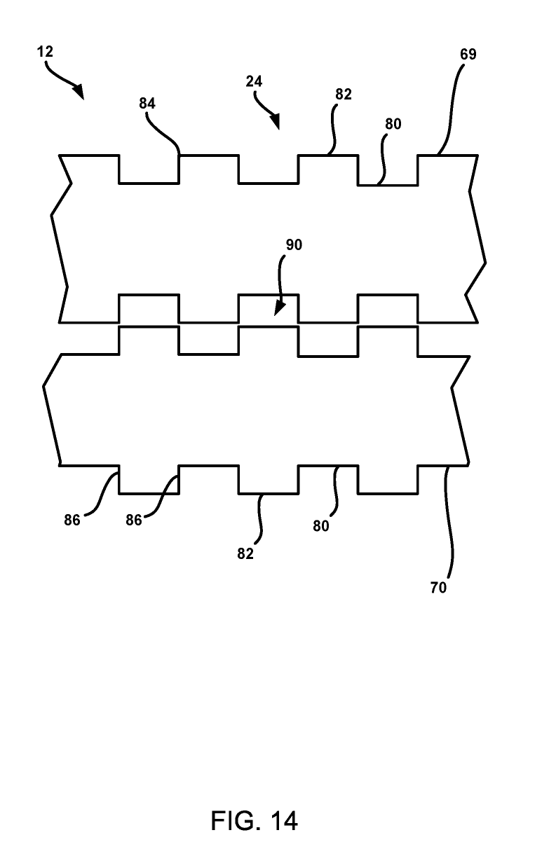

FIGS. 14-17 show alternative expansion members for use with the converter 12. In these alternative embodiments, the alignment of the recessed portions and outward portions of one expansion member relative to the recessed portions and outward portions of the other expansion member are different as compared to the alignment shown in FIGS. 12 and 13. It should be noted that in any of the alternative embodiments, the first (upper) of the expansion members 69 may be exchanged with the second (lower) of the expansion members 70 and vice versa.

For example, the embodiment of FIG. 14 is similar to the embodiment of FIGS. 12 and 13, except that in the embodiment of FIG. 14 the plurality of outward portions 82 of each of the expansion members 69 and 70 are not interwoven with the plurality of outward portions 82 of the other of the expansion members 69 and 70. The plurality of outward portions 82 of each of the expansion members 69 and 70 do not extend into and are not received between respective ones of the plurality of outward portions 82 of the other of the expansion members 69 and 70.

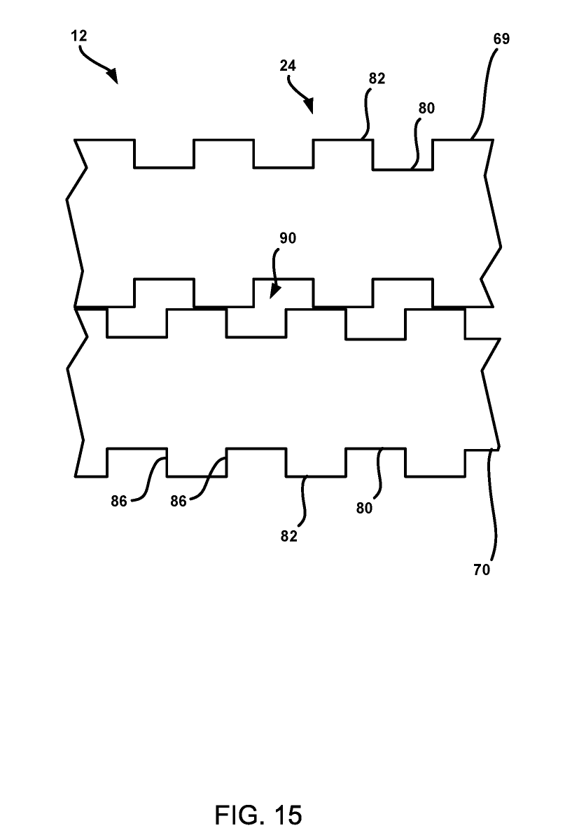

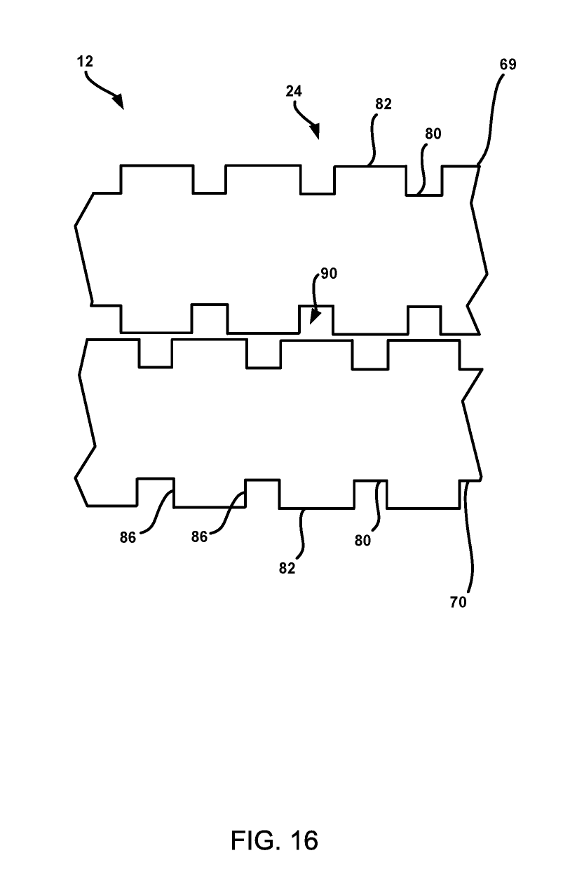

Each of the embodiments of FIGS. 15 and 16 is also similar to the embodiment of FIGS. 12 and 13, in that the plurality of recessed portions 80 of each of the expansion members 69 and 70 are axially offset from the plurality of recessed portions 80 of the other of the expansion members 69 and 70 along the respective expansion axes 72. There is further similarity in that the plurality of recessed portions 80 of each of the expansion members 69 and 70 are alternately axially aligned with respective ones of the plurality of outward portions 82 of the other of the expansion members 69 and 70 along the respective expansion axes 72.

The embodiment of FIG. 15 differs from the embodiment of FIGS. 12 and 13 in that in the embodiment of FIG. 15, the recessed portions 80 of each of the expansion members 69 and 70 each axially overlap both a corresponding recessed portion 80 and a corresponding outward portion 82 of the other of the expansion members 69 and 70. Thus in FIG. 15, the respective lateral sides 86 do not overlap as in FIGS. 12 and 13.

The embodiment of FIG. 16 differs from the embodiment of FIGS. 12 and 13 in that in the embodiment of FIG. 16, the outward portions 82 of each of the expansion members 69 and 70 each axially overlap one recessed portion 80 of the other of the expansion members 69 and 70, and also axially overlap more than one outward portion 82 of the other of the expansion members 69 and 70. And the plurality of recessed portions 80 of each of the expansion members 69 and 70 do not axially overlap respective ones of the plurality of recessed portions 80 of other of the expansion members 69 and 70.

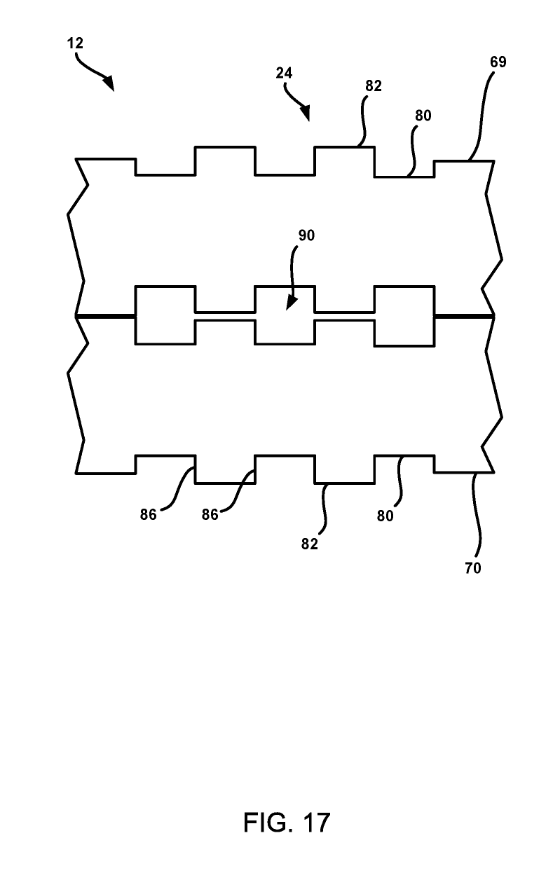

In the alternative arrangement shown in FIG. 17, the outward portions 82 of each the expansion members 69 and 70 are generally axially aligned with the outward portions 82 of the other of the expansion members 69 and 70 along the respective expansion axes 72. Likewise, the recessed portions 80 of each of the expansion members 69 and 70 are generally axially aligned with the recessed portions 80 of the other of the expansion members 69 and 70 along the respective expansion axes 72. In this way, the first expansion member 69 (upper) mirrors the second (lower) expansion member 70.

Further, in FIG. 17, only a portion of the plurality of outward portions 82 of the expansion members 69 and 70 may engage one another. For example, the outward portions 82 of the plurality of outward portions 82 that are disposed adjacent opposing axial ends of the expansion members 69 and 70 may engage one another, and the outward portions 82 of the plurality of outward portions 82 that are disposed axially centrally along the respective expansion axes 72 may not engage one another, but instead may be spaced from one another. In this way, the pair of opposed expansion members 69 and 70 may be configured to provide equivalent force at the opposed axial ends of the expansion members 69 and 70 on sheet stock material drawn between the opposed expansion members 69 and 70, but non-uniform force across the width of the sheet stock material extending between the axial ends of the expansion members 69 and 70. In other embodiments, each of the outward portions 82 of the plurality of outward portions 82 of the respective expansion members 69 and 70 engage one another, such as illustrated in FIG. 13.

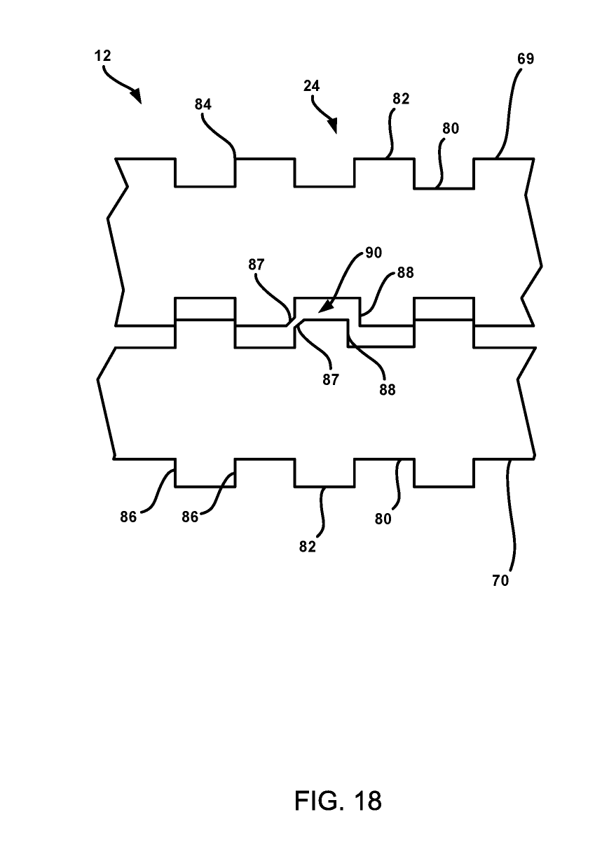

Next, as shown in FIG. 18, a pair of expansion members 69 and 70 may include interwoven outward portions 82, such as in FIGS. 12 and 13. Additionally in such example embodiment, edges 84 or lateral sides 86 of outward portions 82 disposed adjacent opposing axial ends of the expansion members 69 and 70 may engage one another. Although, edges 84 or lateral sides 86 of outward portions 82 disposed axially centrally along the respective expansion axes may not engage one another, but instead may be spaced from one another. For example, to achieve this non-engagement, axially centrally disposed outward portions 82 may include one or more beveled or chamfered edges, such as edges 87 illustrated in FIG. 18. Additionally or alternatively, to achieve this non-engagement, axially centrally disposed outward portions 82 may include one or more lateral edges spaced from one another, such as lateral edges 88 illustrated in FIG. 18. In this way, similar to the pair of expansion members shown in FIG. 17, the pair of opposed expansion members 69 and 70 may be configured to provide equivalent force at the opposed axial ends of the expansion members 69 and 70 on sheet stock material drawn between the opposed expansion members 69 and 70, but non-uniform force across the width of the sheet stock material extending between the axial ends of the expansion members 69 and 70. Moreover, features of any of the embodiments of FIGS. 12-18 may be combined with features of any of the other embodiments of FIGS. 12-18.

Referring now generally to the embodiments of FIGS. 12-18, the alternating construction of the recessed portions 80 and outward portions 82 allows for non-engaged portions of the pair of expansion members 69 and 70. These non-engaged portions define gaps 90 between the expansion members 69 and 70. In the depicted embodiment of FIGS. 12,13 and 18, the gaps 90 are defined between alternately axially aligned recessed portions 80 of one of the expansion members 69 and 70 and outward portions 82 of the other of the expansion members 69 and 70. In the alternative depicted embodiments of FIGS. 14-17, the gaps 90 may be of different size and number depending on alignment of the recessed and outward portions 80 and 82 of each of the adjacent expansion members 69 and 70 relative to one another. For example, axial alignment of the outward portions 82 of each of the expansion member 69 and 70 (FIG. 17) may provide for less gaps 90 than that depicted in the embodiment of FIGS. 12 and 13.

The recessed and outward portions 80 and 82 are believed to help reduce or minimize tearing, wrinkling, and jamming of the sheet material at or near the expansion assembly 24. Along a lateral width dimension of the sheet material between the expansion members 69 and 70, only portions of the sheet material adjacent the recessed portions 80 or downstream of the expansion members 69 and 70 will be able to volumetrically expand. By preventing simultaneous expansion of all of the slits 40 between the expansion members 69 and 70, and by delaying movement of some of the un-slit portions 48, the incidence of tearing, and thus also of associated wrinkling, jamming, and binding of the sheet material is reduced or limited. This incidence may be particularly reduced at start up or at initial drawing of the sheet material from the supply 14 to the output area 28.

Moreover, the zig-zag or up-and-down pattern imposed on the sheet material passing between the expansion members 69 and 70 is believed to cause some of the slits to cause some of the slits to “pop” and be more inclined to open after passing the expansion members 69 and 70. The “pop” may refer to movement of the unexpanded slit in a normal or thickness direction and out of the plane of the paper. The construction of the expansion members 69 and 70 also provides for a more uniform expansion of the slits 40 throughout the sheet material, as compared to the use of non-recessed or non-relieved members as expansion members.

More particularly, the recessed and outward portions 80 and 82 allow for sections of the sheet material between the expansion members 69 and 70 to expand volumetrically into the gaps 90. Concurrently, other sections of the sheet material between the engaged or nearly engaged portions of the expansion members 69 and 70 may only expand generally longitudinally or laterally, or may be tightly gripped preventing any longitudinal or lateral expansion. Further, expansion in the normal or thickness direction generally is prevented between the engaged or nearly engaged portions of the expansion members 69 and 70. Between the engaged or nearly engaged portions of adjacent expansion members 69 and 70, the sheet material will be most tightly gripped, thereby generally preventing rotation of the un-slit portions 48 out of the plane of the sheet material.

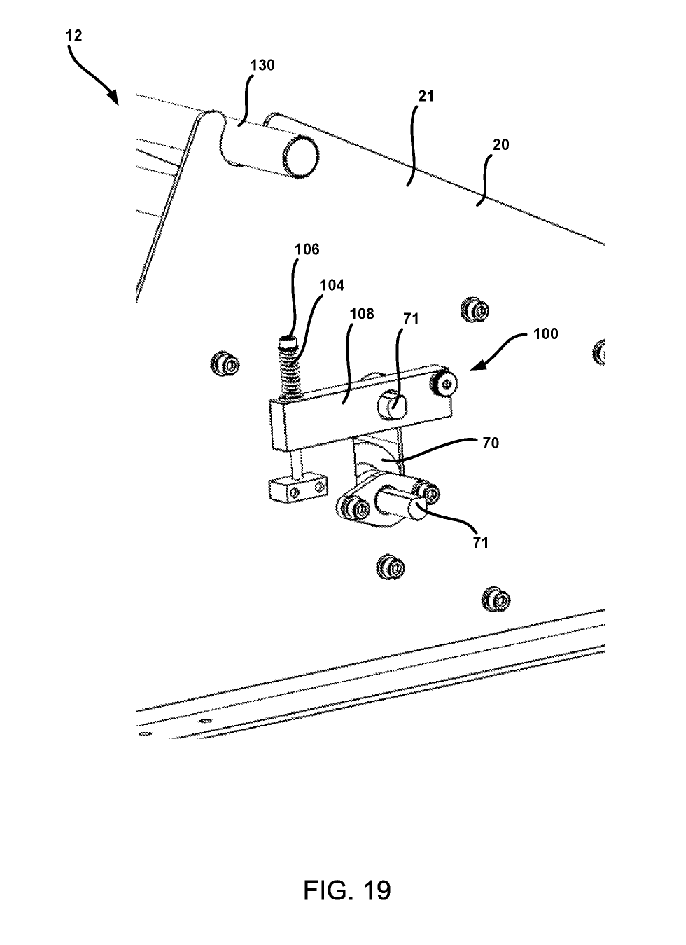

Turning now to FIG. 19, the converter 12 of the embodiment of FIGS. 1-13 further includes a biasing assembly, depicted at 100 for biasing at least one of the expansion members 69 and 70 towards the other of the expansion members 69 and 70, and in the depicted embodiment for biasing the upper expansion member 69 relative to the lower biasing member 70. Generally the pair of opposed expansion members 69 and 70 and the biasing assembly 100 are configured to provide equivalent force at the opposed axial ends of the expansion members 69 and 70 on the sheet stock material 16 drawn between the opposed expansion members 69 and 70, but non-uniform force across the lateral width of the sheet stock material 16 extending between the axial ends of the expansion members 69 and 70.

Once the biasing assemblies 100 are set, the upper expansion member 69 may move relative to the lower expansion member 70, allowing for different thicknesses of sheet material or wrinkled portions of the sheet material to pass between the expansion members 69 and 70 without causing jamming or binding. This arrangement allows the converter 12 to maintain a consistent gripping force on the sheet material drawn through the expansion assembly 24.

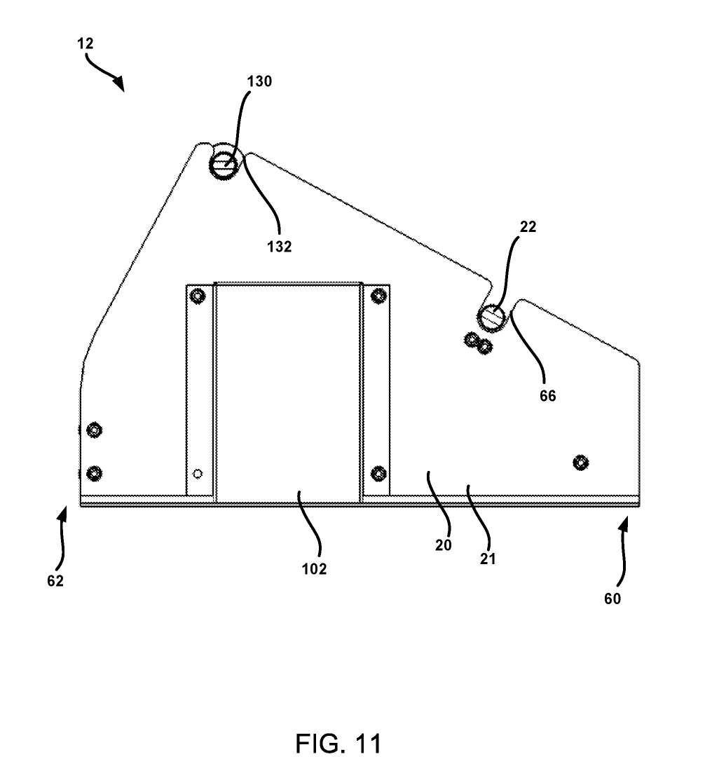

A biasing assembly 100 is included at each of the opposing lateral sides of the converter 12, although in other embodiments, only one biasing assembly 100 may be included. The biasing assemblies 100 are coupled to the frame sides 21 and to the expansion assembly 24. As shown in FIG. 11, a cover 102 may enclose each tensioning assembly 100 to reduce the chance of foreign objects coming near moving portions of the tensioning assembly 100. The cover 102 may be coupled, such as via screws, bolts, adhesives, notch and key, etc. to the respective frame side 21.

The depicted biasing assemblies 100 each include a biasing element 104 for biasing the upper expansion member 69 towards the lower expansion member 70. The biasing element 104, such as a spring, is disposed about an adjustment member 106, such as a screw, that is threadedly engaged to the respective frame side 21. The adjustment members 106 may be adjusted via a tool through openings 107 (FIG. 8) in the cover 102, thereby eliminating the need to remove the cover 102 during adjustment.

Also coupled to the adjustment member 106 is an end plate 108, pivotably coupled to the respective frame side 21 and to one of the opposed lateral ends of the upper expansion member 69. Adjustment of the adjustment member 106 enables adjustment of the biasing force of the respective biasing element 104. More particularly, rotation of the adjustment member 106 either compresses or expands the biasing member 106, thereby altering the gripping force of the expansion assembly 24.

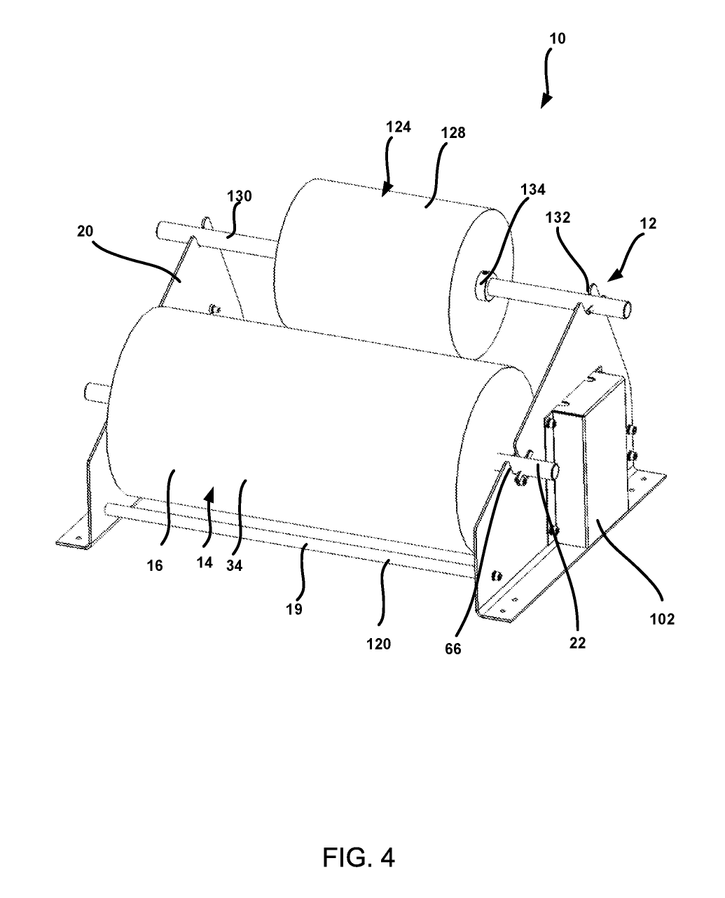

Referring again to FIGS. 4 and 5, the converter 12 may further include an alignment member 120 disposed downstream of the supply support 20 and upstream of the expansion assembly 24. The alignment member 120 may be provided as a cross-beam 19 to support the frame sides 21 or to direct and support the unexpanded slit sheet material 16 from the roll 34 to the expansion assembly 24. The alignment member 120 may assist in maintaining tautness of the sheet material and in preventing wrinkling, tearing, or misalignment of the sheet material between the frame sides 21 as it is drawn from the supply 14 towards the expansion assembly 24. The alignment member 120 also may serve to reduce jamming at the expansion assembly 24. In some embodiments, the alignment member 120 may be a roller, such as rotatable about a central axis of the alignment member 120.

The alignment member 120 is coupled, such as rotatably coupled, to the frame 20, such as between the opposite frame sides 21 as depicted. It will be appreciated that, the alignment member 120, or an additional or alternative alignment member, may be disposed upstream of the supply support 22 between the supply support 22 and the upstream end 60. In other embodiments, any alignment member may be of any suitable shape.

Where the alignment member 120 supports the unexpanded slit sheet material 16 upstream of the expansion assembly 24, the guide roller 26 is disposed downstream of the expansion assembly 24 to provide a similar function for the expanded dunnage product 30. As the unexpanded sheet material 16 is drawn through the expansion assembly 24 and converted to the expanded dunnage product 30, the guide roller 26 assists in supporting the dunnage product 30 at or near the output area 28, where the guide roller 26 is generally disposed. The guide roller 26 is positioned such that the dunnage product 30 is drawn under the guide roller 26. The positioning may assist in maintaining tautness of the dunnage product 30, distributing tension across the width of the stock material, and preventing wrinkling, tearing, or misalignment of the dunnage product 30 between the frame sides 21 as it is drawn from the expansion assembly 24.

The guide roller 26 is coupled, such as rotatably coupled, to the frame 20 via any suitable means, such as between the opposite frame sides 21 as depicted. It will be appreciated that one or more guide rollers may be included and that in other embodiments, the guide roller 26, or an additional or alternative guide roller, may be disposed downstream of the expansion assembly 24. A guide roller may be disposed at any suitable location downstream of the expansion assembly 24, such as adjacent the downstream end 62 in the output area 28 as depicted. The guide roller 26 may be of any suitable shape, and thus may not be cylindrical as depicted. In some embodiments, the guide roller 26 may not be rotatable with respect to the frame 20.

The guide roller 26 may be positioned any suitable distance from the expansion assembly 24. For example, depending on the length of the slits 40, alignment of the rows of slits 40, number of slits 40, alignment of the slits 40, or other characteristics of the sheet material 16, etc., the distance between the expansion assembly 24 and the guide roller 26 may be adjusted to provide optimum tension on the expanding sheet material and thus optimum volumetric expansion of the sheet material. The frame 20 also may include alternative locations, such as attachment holes, for coupling the guide roller 26 to the frame at different locations. In other embodiments the guide roller 26 may be slidingly adjustable along the frame 20, such as via slots in the frame 20 and respective adjustable coupling members of the guide roller 26 for coupling to the frame 20.

The dunnage conversion system 10 may further include, and thus the converter 12 may be provided in combination with a separator supply 124 of separator sheet material 126 for use as a separator sheet between the resultant dunnage product 30 and a product to be protected by the dunnage product 30. An exemplary separator sheet material 126, also herein referred to as interleaf paper, may be a tissue paper, thin kraft paper such as thinner than the slit sheet stock material 16, plastic, a combination thereof, etc. Like the supply 14, the separator supply 124 may be provided as a roll 128, such as wound about a hollow core that may be received on a respective supply support. Additionally or alternatively, the separator supply 124 may be provided in a fan folded stack, and an associated supply support may include a shelf for supporting the stack.

Accordingly, a separator supply support 130 is provided for engaging the frame 20, such as for engaging indents, such as notches 132, in the opposing frame sides 120. Thus the supply support 132 may be coupled, such as rotatably coupled, to the frame 20 to permit rotation of the roll 128 as the separator material is drawn off the roll 128. In other embodiments the separator supply support 130 may be fixedly coupled to the frame 20 and the separator supply 124 may rotate about the separator supply support 130.

As depicted, the separator supply support 130 is disposed vertically above and horizontally downstream of the supply support 22. Though in other embodiments, the separator supply support 130 may be disposed vertically even with or vertically below the supply support 22. Additionally or alternatively, in some embodiments, the separator supply support 130 may be disposed horizontally even with or horizontally upstream of the supply support 22.

One or more guide portions, such as guide collars 134 may be provided, such as on the supply support 22 for maintaining transverse alignment of the rolled separator supply 124 along the separator supply support 130 and between the frame sides 21. For example, a guide collar 134 may be provided at each of the opposing axial ends of the roll 128 about the separator supply support 130, as depicted. In other embodiments, additional or alternative guide portions may be attached or integral with the frame 20.

The depicted converter 12 also includes a separator guide roller 140 coupled, such as rotatably coupled, to the frame 20 for guiding the separator sheet material 126 at the output area 28 of the converter 12. The separator sheet is not slit and does not expand, so there is no need to feed the separator sheet through the expander rollers 70. The separator guide roller 140 guides the separator sheet material past the expansion assembly. As shown, the central axes of the guide roller 140 and the guide roller 26 are disposed parallel one another. The separator sheet material 126 is separated at the output area 28 from the expanded dunnage product 30 via the guide roller 26 while the guide rollers 140 and 26 bring the expanded dunnage product 30 and the separator sheet material 126 into parallel, overlapping paths. In some embodiments, the guide roller 140 may not rotate relative to the frame 20.

In summary, the present invention provides a dunnage conversion machine 12 that includes a frame 20, a supply support 22 coupled to the frame 20 for supporting a supply 14 of expandable sheet stock material 16, and a pair of opposed expansion members 69 and 70 rotatably coupled to the frame 20 for rotation about respective expansion axes 72. The expandable sheet stock material 16 is gripped between the expansion members 69 and 70 while it is drawn between the expansion members 69 and 70. Tension provided between a downstream pulling force downstream of the expansion members 69 and 70 and the gripping force of the expansion members 69 and 70 causes expansion of the expandable sheet stock material 16. Portions of the expansion members 69 and 70 are periodically recessed to provide more uniform expansion of the expandable sheet stock material 16 while reducing or altogether preventing jamming of expanding sheet stock material 16 between the expansion members 69 and 70, or tearing of the expanding sheet stock material 16 adjacent the expansion members 69 and 70.

There present invention also provides a method of dispensing the expanded slit sheet stock material 16 using a dunnage conversion system 10 that includes the frame 20, the supply of expandable sheet stock material 14 supported on the supply support 22 coupled to the frame 20, and the pair of opposed expansion members 24 downstream of the supply support 22 for gripping the sheet stock material 16 passing between the expansion members 24. The method includes the steps of (a) pulling the sheet stock material 16 at a location adjacent an output 28 of the system 10 in a direction outwardly from the system 10, (b) maintaining consistent gripping force on the sheet stock material 16 drawn between the expansion members 69 and 70, and (c) expanding the expandable sheet stock material 16 via tension between the pulling force at the output 28 and the gripping force applied to the sheet stock material 16 by the expansion members 69 and 70.

Although the invention has been shown and described with respect to a certain illustrated embodiment or embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiment or embodiments of the invention.

1. A dunnage conversion machine, comprising:
a frame;
a supply support coupled to the frame for supporting a supply of sheet stock material; and
a pair of expansion members rotatably coupled to the frame for rotation about respective expansion axes, and being spaced apart to grip sheet stock material therebetween, where the expansion members each include a plurality of recessed portions and outward portions alternatingly distributed along the respective expansion axes between opposite ends of the respective expansion members, at least some of the plurality of outward portions of a first of the expansion members being aligned with at least a portion of at least a respective one of the plurality of outward portions of a second of the expansion members to grip the sheet stock material between the opposed outward portions of the respective expansion members.

2. The dunnage conversion machine of claim 1, where the plurality of recessed portions extend fully circumferentially about each of the respective expansion members thereby defining recessed rings.

3. The dunnage conversion machine of claim 1, where the plurality of recessed portions of each of the expansion members are equally axially spaced from one another along the respective ones of the expansion axes, separated by the respective plurality of outward portions.

4. The dunnage conversion machine of claim 1, where the plurality of recessed portions of a first of the expansion members are axially aligned with respective ones of the plurality of recessed portions of the second of the expansion members along the expansion axes.

5. The dunnage conversion machine of claim 1, where the plurality of recessed portions of a first of the expansion members are axially offset from the plurality of recessed portions of the second of the expansion members along the expansion axes, such that a plurality of recessed portions of the first of the expansion members axially overlap respective ones of the plurality of outward portions of the second of the expansion members.

6. The dunnage conversion machine of claim 1, where the plurality of recessed portions of a first of the expansion members are alternately axially aligned with respective ones of the plurality of outward portions of the second of the expansion members along the expansion axes.

7. The dunnage conversion machine of claim 6, where the recessed portions of the first of the expansion members do not axially overlap any of the plurality of recessed portions of the second of the expansion members along the expansion axes.

8. The dunnage conversion machine of claim 1, where the plurality of outward portions of the expansion members engage respective outward portions of the opposing expansion members.

9. The dunnage conversion machine of claim 1, where only a portion of the plurality of outward portions of the opposing expansion members engage one another while the remainder of the plurality of outward portions of the opposing expansion members are respectively positioned such that they cannot engage one another.

10. The dunnage conversion machine of claim 9, where outward portions of the plurality of outward portions that are disposed adjacent opposing axial ends of the opposing expansion members engage one another, and where outward portions of the plurality of outward portions that are disposed axially centrally along the respective expansion axes and spaced from the opposing axial ends do not engage one another.

11. The dunnage conversion machine of claim 1, where at least one of the expansion members is biased towards the other of the expansion members via a biasing element.

12. The dunnage conversion machine of claim 1, in combination with a supply of sheet stock material including a sheet stock material having a plurality of slits configured to expand under tension applied in a feed direction.

13. The dunnage conversion machine of claim 12, where the supply of sheet stock material in combination with the dunnage conversion machine includes the plurality of slits arranged in a plurality of transversely-extending, longitudinally-spaced rows.

14. The dunnage conversion machine of claim 13, further including a second supply support for supporting a supply of separator sheet material, and in combination with a supply of separator sheet material supported on the second supply support.

15. The dunnage conversion machine of claim 1, where the plurality of outward portions of a first of the expansion members are interwoven with the plurality of recessed portions of the second of the expansion members such that the plurality of outward portions of the first of the expansion members extend radially outwardly into and are received by the plurality of recessed portions of the second of the expansion members.

16. The dunnage conversion machine of claim 1, where the expansion axes are generally parallel one another.

17. A dunnage conversion machine, comprising:
a frame;
a supply support coupled to the frame for supporting a supply of sheet stock material; and
a pair of opposed expansion members downstream of the supply support extending between opposed axial ends, the expansion members being rotatably coupled to the frame for rotation about respective opposed axes, and between which sheet stock material is drawn from the supply of sheet stock material; and
a biasing element coupled to at least one of the expansion members to bias the at least one of the expansion members towards the other of the expansion members to maintain a consistent gripping force on the sheet stock material between the expansion members,
where the pair of opposed expansion members and biasing element are configured to provide equivalent force at the opposed axial ends of the expansion members on sheet stock material drawn between the opposed expansion members, but non-uniform force across the width of the sheet stock material extending between the axial ends of the expansion members.

18. The dunnage conversion machine of claim 17, further including an adjustment member coupled to the biasing element and to the frame, such that the biasing force of the biasing element may be adjusted.

19. The dunnage conversion machine of claim 17, further including another biasing element coupled to the at least one of the expansion members, such the biasing element and the another biasing element are oppositely disposed at the opposed axial ends of the at least one of the expansion members.

20. A method of dispensing an expanded slit sheet stock material using a dunnage conversion system including a frame, a supply of expandable sheet stock material supported on a supply support coupled to the frame, and a pair of opposed expansion members downstream of the supply support for gripping the sheet stock material passing between the expansion members, the method comprising the steps of:
pulling the sheet stock material at a location adjacent an output of the system in a direction outwardly from the system,
maintaining consistent gripping force on the sheet stock material drawn between the expansion members at opposed axial ends of the expansion members, but non-uniform gripping force across a width of the sheet stock material extending between the axial ends of the expansion members, and
expanding the expandable sheet stock material via tension between the pulling force at the output and the gripping force applied to the sheet stock material by the expansion members.

21. (canceled)
